(19) United States
(12) Patent Application Publication
(10) Pub. No.: US 2012/0182421 A1
(43) Pub. Date: Jul. 19, 2012

(54) GPS DEVICE WITH INTEGRAL CAMERA

(76) Inventor: Pavel ASANOV, Staten Island, NY (US)

(21) Appl. No.: 13/070,639

(22) Filed: Mar. 24, 2011

Related U.S. Application Data
(60) Provisional application No. 61/433,552, filed on Jan. 18, 2011.

(51) Int. Cl. H04N 7/18

(52) U.S. Cl. 348/148; 348/E07.085

(57) ABSTRACT

A GPS device includes GPS receiver/calculator that receives and calculates signals from satellites and generates locational data, a camera selectively taking images of inside or outside the motor vehicle and a processor that processes the images, and them with GPS location information.

### RELATED APPLICATIONS

This application claims priority to U.S. Provisional application Ser. No. 61/433,552 filed on Jan. 18, 2011 and incorporated herein in its entirety.

### BACKGROUND OF THE INVENTION

A. Field of Invention

This invention pertains to an improved GPS device including a camera suited for taking images, including moving images of a field of view directed at the direction of movement as the device is mounted on a motor vehicle

B. Description of the Invention

As more and more motor vehicles hit the road, go at a faster and faster speed and are operated by an aging population, the number of accidents between motor vehicles as well as between the motor vehicles and pedestrians or stationary objects are on the increase as well. These accidents are frequently the cause of injuries as well as damage and loss to property and the law enforcement agencies as well as insurance companies are left with the unenviable task of determining exactly how each accident happened and how can be prevented in the future.

The present invention provides a solution that helps solve this problem.

### SUMMARY OF THE INVENTION

This application pertains to a GPS device with a camera configured to monitor the movement of a motor vehicle visually. The device is mounted on a motor vehicle with a screen positioned to provide information to the driver and/or passenger. The camera is built into the device so that it can take still or moving images preferably at regular intervals or continuously. The GPS can be either a portable aftermarket device or can be built into the dashboard.

During the operation of the motor vehicle, the device takes images at regular intervals and stores the images together with timing and geotagging information in a local memory and/or uploads the images to a remote location.

At a later time, the images can be viewed to determine what was happening in the field of view of the camera. This information is important in case of accidents or other events.

### DETAILED DESCRIPTION OF THE DEVICE

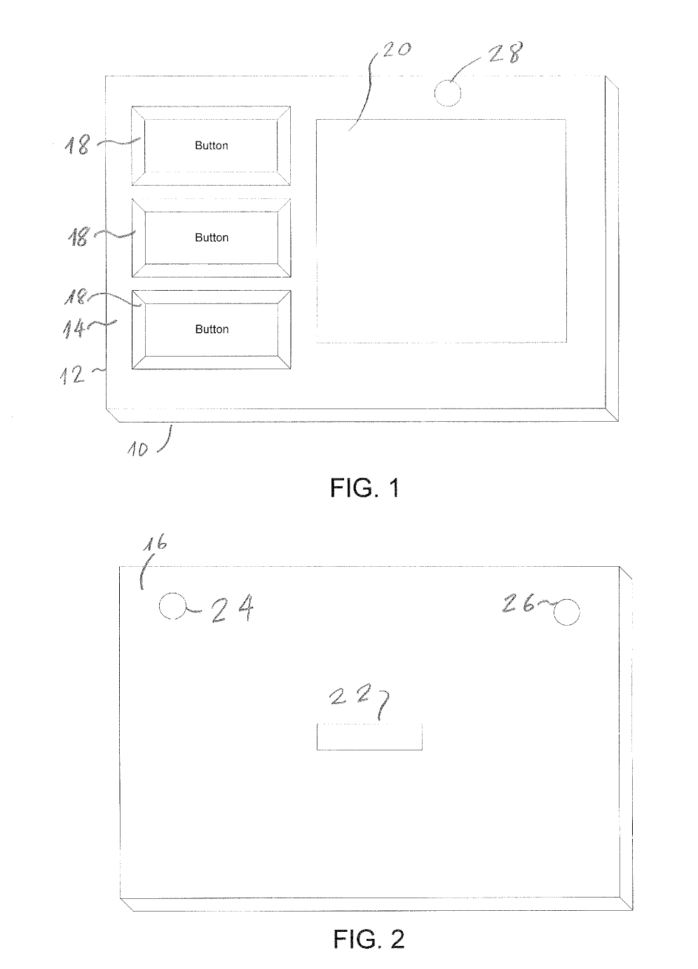

FIG. 1 shows a view of a GPS device constructed in accordance with this invention:

FIG. 2 shows a back view of the device of FIG. 1

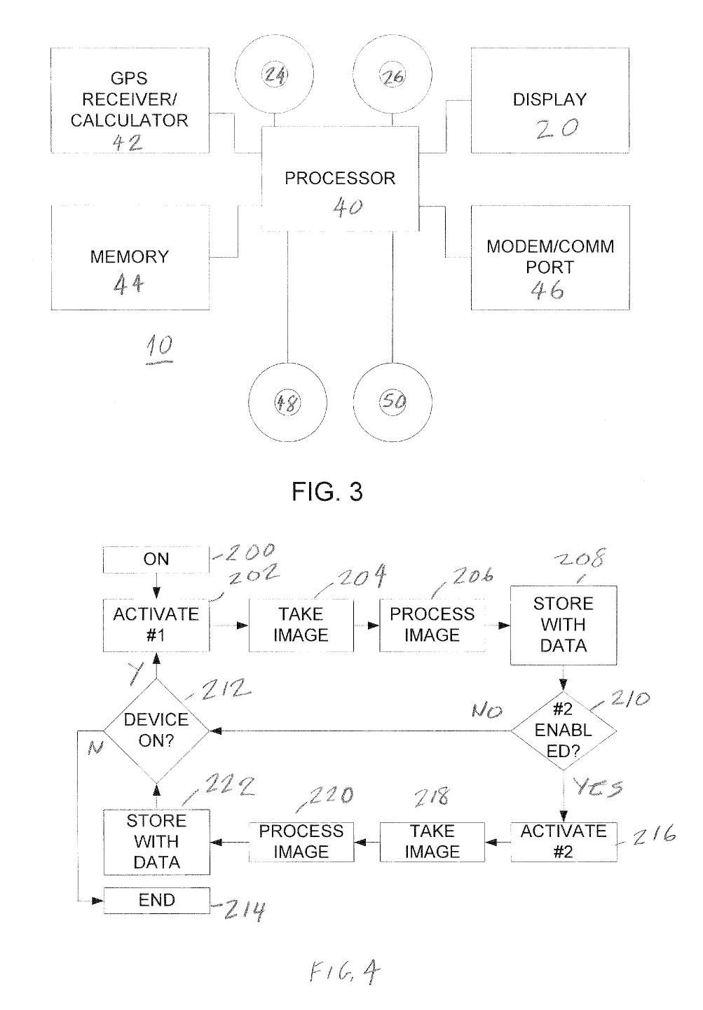

FIG. 3 shows block diagram of the device; and

FIG. 4 shows a flow chart for operating the device of FIGS. 1-3.

### DETAILED DESCRIPTION OF THE INVENTION

Referring first to FIGS. 1 and 2, a GPS 10 with a housing 12 having a front face 14 and a back face 16. In a first embodiment, device 10 is an aftermarket device that is normally bought by the user from a third party vendor and used in a motor vehicle.

The housing 12 is arranged and constructed to be mounted on a dashboard, windshield, side window or other accessible location that is out of the main field of vision of the driver but still can be viewed. The front face 14 is provided with several buttons 18 and a display 20. The buttons are used to activate the device 10 and to enter various commands, such as addresses, points of interest, etc, associated with the operation of the GPS. According to the present invention, the buttons 18 may also be used to activate the camera(s) as discussed in more detail below. It should be understood that in the figures device 10 is shown with three buttons 18 for the sake of clarity however the device 10 may have more or less button and they can be disposed anywhere on the housing 12. The display 20 is shown as being separate from the buttons 18, however, the display 20 can also be provided with a touch screen (not shown) and all or some of the buttons 18 can be implemented as virtual or soft keys that appear on the screen as needed and are activated using the touchscreen.

On the back face 14, the device 10 is provided with a mounting member 22 which can include a suction cup and/or other similar means well known in the art and used to mount the device 10 on the dashboard, windshield, etc. In addition, back face 16 also holds a camera 24. In an alternate embodiment, the device 10 can include a second camera 26 also mounted on the back face 16, the two cameras 24, 26 being arranged and constructed forwardly in different directions as the device 10 is mounted on the dashboard. For example, camera 24 could be oriented somewhat toward the right and camera 26 can be oriented forward and somewhat toward the left.

In another embodiment, instead of, or in addition to camera 26, device 10 may be provided with a third camera 28 disposed on front face 14 and arranged to monitor either the interior of the car or to the rear of the camera through the rear window.

FIG. 3 shows some of the major components of the device 10. The device includes a processor 40, a GPS receiver/calculator 42, a memory 44, and optionally, a modem/communication port 46. The controller is also connected to cameras 24, 26 as well as display 20. In an alternate embodiment, the device 10 can be incorporated into the dashboard or other parts of the motor vehicle in such a manner that display 20 is available for viewing by the driver and/or passenger. In this case, one or more external cameras 48,50 disposed at one or more locations within the motor vehicle for monitoring events inside and outside the motor vehicle.

It should be understood the device 10 includes other elements, such as batteries, chargers, antennas, speakers, that provide power and various functionalities for the device 10 and that have been omitted for the sake of clarity.

Modes of operation of the device 10 shall now be described in conjunction with FIG. 4. The process starts in step 100 when the device 10 is activated, for example by pushing one of the buttons 18. This results with the device 10 being enabled. Once enabled, the GPS receiver/calculator receives signals from satellites and based on these signals, it calculates the current position of the motor vehicle. This information is presented to a driver/passenger on display 20, as coordinates, or more often, superimposed on a virtual map. Data for the map is stored in memory 44. The driver/passenger may also elect to input information to the GPS indicating, for example a desired destination, either by address, name, etc., and the processor 40 uses this information together with data from memory 44 to generate a suggested route on the map that can be used to navigate the motor vehicle to a desired destination. All these main functionalities are standard and the remaining functionalities discussed herein will operate transparently as far as these main functionalities are concerned.

In one mode of operation, once the device 10 is turned on (step 200), first camera 24 is activated (step 202), the camera 24 than takes an image (step 204) which is then processed by controller 40, tagged with the location data from the GOS and the current time data and stored with associated location data obtained by GPS receiver/calculator 42 and other information such as the current time, date, etc. The image and other data can be stored into memory 40. Alternatively, the image and the data can be stored in a separate memory, for example an external memory such as a USB drive, an SD card, etc., and/or can be transmitted on a remote location using modem or corn port 46.

Next, in step 210 a test is performed to determine if a second camera is activated. In some instances, the device 10 may be configured to allow the second camera to be disabled for privacy considerations. If the second camera is off, then a check is performed to determine if the device 10 is still on. If it is, then the first camera is ordered to take another image and the loop repeats itself. If the device 10 has been turned off, the loop is terminated (step 214).

Back in step 210 if the second camera is activated then an image is taken with the second camera, the image is processed and stored as with the images from the first camera (steps 216, 218, 220, 222).

In one embodiment of the invention, the images are stored automatically until the memory used to store the same is full. A message is then presented to change the memory. In another embodiment, a predetermined number of images are stored (or images are stored until a predetermined memory section of e.g., X Gb is reached, after which images are erased on a first in, first out basis. In another embodiment, the images for predetermined time are stored, for example 10 minutes or half an hour. If during this time a signal is received (for example from the driver or from a remote location to indicate that an event of interest has occurred, then all the images for that period including images taken optionally after the store command has been received. If no such control signal is received, the images are deleted, again, on a first in-first out basis.

Numerous modifications may be made to this invention as described in the attached claims.

I claim:

1. A GPS assembly configured for installation in a motor vehicle comprising:
a GPS receiver receiving satellite signals and generating GPS information indicative of the current geographic location of the motor vehicle;
a camera arranged and constructed to selectively take images inside or outside the vehicle; and
a controller receiving and tagging said images using location information from said GPS receiver.

2. The GPS assembly of claim 1 further comprising a memory receiving and storing said tagged images.

3. The GPS assembly of claim 1 further comprising a communication port receiving said tagged images and transmitting same to a remote location.

4. The GPS assembly of claim 1 further comprising a second camera adapted images different from images from said first camera.

5. The GPS assembly of claim 1 wherein said controller is configured to store several images and erase some of the images after they have been stored in a first in first out basis.

6. The GPS assembly further comprising a housing for said camera GPS receiver and controller

7. The GPS assembly of claim 6 further comprising a mounting element for selectively mounting said housing.
